(19) United States
(12) Patent Application Publication
(10) Pub. No.: US 2025/0363604 A1
(43) Pub. Date: Nov. 27, 2025

(54) INFORMATION PROCESSING APPARATUS CAPABLE OF APPLYING LENS ABERRATION CORRECTION TO MOVING IMAGE FILE, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: RYOTA SHOJI, Kanagawa (JP)

(21) Appl. No.: 19/206,369

(22) Filed: May 13, 2025

(30) Foreign Application Priority Data
May 23, 2024 (JP) 2024-084083

(51) Int. Cl. G06T 5/80; H04N 25/611

(52) U.S. Cl. CPC G06T 5/80; H04N 25/611

(57) ABSTRACT

An information processing apparatus that performs CG synthesis on an acquired moving image file. Lens aberration correction for removing lens aberrations is applied to the moving image file before performing the CG synthesis. Whether or not to use settings of lens aberration correction, which have been made before capturing the moving image is switched. In a case where the settings are used, non-applied types of lens aberration correction, which are identified based on the settings, are applied to the moving image file, whereas in a case where the settings are not used, all applicable types of lens aberration correction are applied to the moving image file.

### BACKGROUND

### Field of the Technology

The present disclosure relates to an information processing apparatus that is capable of applying lens aberration correction to a moving image file, a method of controlling the information processing apparatus, and a storage medium.

### Description of the Related Art

In a work flow for computer graphics (hereinafter referred to as the CG) synthesis in virtual production, when synthesizing a real shot video and CG, lens aberration correction for removing lens aberrations, such as peripheral light amount aberration and distortion aberration, from the real shot video is performed before the synthesis. There is no lens aberration at all on the CG side, and hence it is desirable that the real shot video before the CG synthesis is in a state in which all the lens aberrations have been removed. Further, after the CG synthesis, an operation for giving the atmosphere of reality to the CG side is performed by adding lens aberrations of the real shot video to a result of the CG synthesis.

In recent years, a digital camera that is capable of recording a RAW moving image file has appeared, and the RAW moving image file is also used for virtual production because the RAW moving image file has a high degree of freedom in processing a shot video. There is known an image capturing apparatus that records, when recording a RAW moving image file, lens aberration correction data for correcting aberrations of a lens attached to a digital camera, in association with the RAW moving image file (see e.g. Japanese Laid-Open Patent Publication (Kokai) No. 2014-23063). When a RAW moving image file is used for CG synthesis, the lens aberration correction data is acquired from metadata in the RAW moving image file before CG synthesis, whereby it is possible to perform the CG synthesis after removing lens aberrations using the lens aberration correction data.

In the digital camera, a user can set what type of lens aberration is to be corrected (removed) using e.g. a menu of setting items when shooting is performed. For example, when recording a moving image, a user can make a setting of lens aberration correction such that peripheral light amount correction is applied but distortion aberration correction is not applied. When recording a moving image file of e.g. MP4, the digital camera records a video shot by applying lens aberration correction according to settings made before shooting, as the moving image file. On the other hand, when recording a RAW moving image file, in general, the digital camera records, without applying lens aberration correction, settings of lens aberration correction, which have been made before shooting, in the metadata included in the RAW moving image file. By doing this, it is possible to apply lens aberration correction according to the settings made before shooting when the RAW moving image file is developed.

Incidentally, in the work flow for virtual production, cut editing is sometimes performed with respect to a moving image file before CG synthesis. At this time, the moving image file is sometimes converted to another file format, such as the Open EXR format. When the moving image file is converted to another file format, there are many cases where the metadata generated before shooting and stored in the moving image file is not transferred to the converted file. Therefore, before a cut editing operation, the user performs, using an application made by a camera maker, an operation of outputting the metadata stored in the moving image file as a metadata file, which is a separate file from the moving image file. By preparing the metadata file, it is possible to apply lens aberration correction to each frame image of the moving image file, which has been subjected to cut editing and converted to the other file format, according to the settings made before shooting, before CG synthesis.

Although development processing is required to display a RAW moving image file, not only the application made by the camera maker, but also a general editing system sometimes supports RAW moving image development designed by each camera maker. For example, DaVinci Resolve of Blackmagic Design company supports RAW moving image development of a variety of camera makers. However, the editing system cannot always analyze a metadata file output from the application made by a camera maker in the processing for developing a RAW moving image file, and cannot apply lens aberration correction according to settings of lens aberration correction, which are stored in the metadata file. Therefore, even when the user has made a setting of applying a certain lens aberration correction before shooting, not only this lens aberration correction, but also other lens aberration correction is not applied to development performed by the editing system. This causes a problem that the settings of lens aberration correction, which are stored in the metadata file, and the applied state of lens aberration correction in the moving image file output by the editing system do not match, which makes it impossible to form the moving image file before CG synthesis into a state in which all lens aberrations have been removed.

A case will be described, by way of example, in which CG synthesis is performed using a RAW moving image file formed by recording settings of lens aberration correction made before shooting for not applying distortion aberration correction and applying lens aberration correction other than the distortion aberration correction, as metadata, and a metadata file of the metadata output from the RAW moving image file. In development processing for displaying this RAW moving image file, originally, other types of lens aberration correction than the distortion aberration correction are applied according to the above-mentioned settings made before shooting, which are included in the metadata file. Further, by applying the distortion aberration correction, which has not been applied according to the above-mentioned settings made before shooting, to the developed moving image file, this moving image file is formed into a state in which all lens aberrations have been removed before CG synthesis. However, in a case where the development processing for displaying the RAW moving image file is performed by the editing system, the editing system cannot interpret the metadata file output from the RAW moving image file, and hence none of the types of lens aberration correction are applied to the RAW moving image file. Even when the distortion aberration correction which has not been applied is applied to the developed moving image file according to the above-mentioned settings made before shooting, which are included in the metadata file, the moving image file is in a state in which the other types of lens aberration correction other than distortion aberration correction have not been applied. That is, this moving image file is in a state in which part of lens aberrations has not been removed before CG synthesis. Thus, the conventional technique has a problem that it is impossible to apply all the applicable types of lens aberration correction to a moving image file before CG synthesis.

### SUMMARY

The present disclosure provides an information processing apparatus that is capable of applying all applicable types of lens aberration correction to a moving image file before CG synthesis, a method of controlling the information processing apparatus, and a storage medium.

In a first aspect of the present disclosure, there is provided an information processing apparatus that performs CG synthesis on an acquired moving image file, including at least one processor, and a memory coupled to the at least one processor storing instructions that, when executed by the processor, cause the processor to function as an application unit configured to apply lens aberration correction for removing lens aberrations to the moving image file before performing the CG synthesis, and a switching unit configured to switch whether or not to use settings of lens aberration correction, which have been made before capturing the moving image, wherein in a case where the settings are used, the application unit applies non-applied types of lens aberration correction, which are identified based on the settings, to the moving image file, whereas in a case where the settings are not used, the application unit applies all applicable types of lens aberration correction to the moving image file.

In a second aspect of the present disclosure, there is provided a method of controlling an information processing apparatus that performs CG synthesis on an acquired moving image file, including applying lens aberration correction for removing lens aberrations to the moving image file before performing the CG synthesis, and switching whether or not to use settings of lens aberration correction, which have been made before capturing the moving image, wherein in a case where the settings are used, the applying includes applying non-applied types of lens aberration correction, which are identified based on the settings, to the moving image file, whereas in a case where the settings are not used, the applying includes applying all applicable types of lens aberration correction to the moving image file.

Further features of the present disclosure will become apparent from the following description of exemplary embodiments (with reference to the attached drawings).

### BRIEF DESCRIPTION OF THE DRAWINGS

FIG. 1 is a block diagram schematically showing a configuration of a personal computer (PC) as an information processing apparatus according to a first embodiment.

FIG. 2 is a flowchart of a metadata file output process performed by the PC shown in FIG. 1.

FIG. 3 is a diagram showing an example of a configuration of a metadata file output by the metadata file output process in FIG. 2.

FIG. 4 is a flowchart of a CG synthesis control process performed by the PC in the first embodiment.

FIG. 5 is a flowchart of a file format conversion process performed by a PC in a second embodiment.

FIG. 6 is a flowchart of a CG synthesis control process performed by the PC in the second embodiment.

### DESCRIPTION OF THE EMBODIMENTS

The present disclosure will now be described in detail below with reference to the accompanying drawings showing embodiments thereof. In the present embodiment, a personal computer (hereinafter referred to as the “PC”) that handles a moving image file will be described as an example of an information processing apparatus. Further, it is assumed that, in a digital camera that provides a moving image file to the information processing apparatus, before shooting is performed, as settings of lens aberration correction, respective ON/OFF settings of types of lens aberration correction, i.e. peripheral light amount correction, magnification chromatic aberration correction, distortion aberration correction, and focus breathing correction can be individually made. Note that the peripheral light amount correction is processing for correcting lowering of a peripheral light amount, which is a phenomenon that four corners of an image become dark depending on characteristics of a lens and shooting conditions. The magnification chromatic aberration correction is processing for correcting magnification chromatic aberration, which is a phenomenon that coloring appears on edges in the periphery of an image, due to characteristics of a lens. The distortion aberration correction is processing for correcting distortion aberration, which is a phenomenon that distortion is generated in an image due to characteristics of a lens. The focus breathing correction is processing for reducing variation of an angle of view, which is caused by a change in a focusing position during moving image shooting.

First, the information processing apparatus according to a first embodiment of the present disclosure and a method of controlling the same will be described.

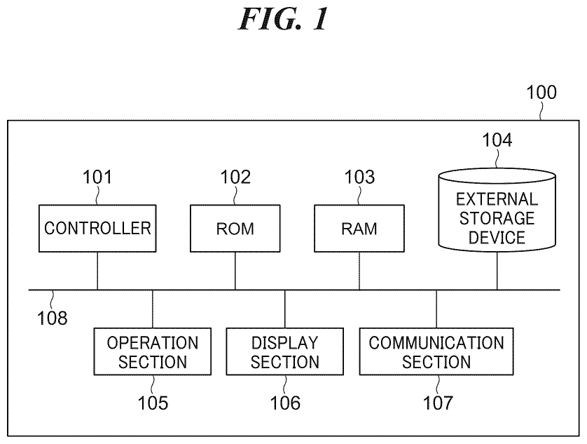

FIG. 1 is a block diagram schematically showing a configuration of a PC 100 as the information processing apparatus according to the present embodiment. Referring to FIG. 1, the PC 100 includes a controller 101, a ROM 102, a RAM 103, an external storage device 104, an operation section 105, a display section 106, and a communication section 107. These are interconnected via a bus 108. Note that ROM is an abbreviation of read only memory. RAM is an abbreviation of random access memory.

The controller 101 is e.g. a central processing unit (CPU) and controls the overall operation of the PC 100. The ROM 102 stores programs and parameters, which do not require changes. The RAM 103 temporarily stores a program and data, supplied e.g. from an external apparatus. The external storage device 104 is a storage device, such as a hard disk or a flash memory provided in the PC 100, or a memory card which can be removably attached to the PC 100. The operation section 105 is a mouse, a keyboard, a touch panel, and so forth, for receiving a user's operation. The display section 106 displays data held by the PC 100 and data supplied to the PC 100. Note that by connecting an external display device to the PC 100, data can be displayed on the display device. The communication section 107 performs data communication with an external apparatus, such as a digital camera.

The PC 100 acquires, for example, a moving image file (hereinafter also referred to as the “camera-recorded moving image file”) recorded through shooting performed by a digital camera from the digital camera and stores the acquired moving image file in the external storage device 104. The camera-recorded moving image file is a non-RAW moving image file or a RAW moving image file.

The non-RAW moving image file is a moving image file, such as a moving image file of e.g. MP4, to which lens aberration correction has been applied by the digital camera according to the settings of lens aberration correction, which have been made by a user before shooting. Further, the non-RAW moving image file includes lens aberration correction data for correcting aberrations of a lens attached to the digital camera.

The RAW moving image file is a moving image file to which lens aberration correction has not been applied by the digital camera. The RAW moving image file includes metadata including settings of lens aberration correction, which have been made by a user before shooting, and the lens aberration correction data. Thus, the camera-recorded moving image file includes at least the lens aberration correction data.

The PC 100 includes software modules, such as an editing system, a CG synthesizing system, and a metadata file-outputting tool, that perform a variety of processing operations using the camera-recorded moving image file.

The editing system performs cut editing, transition addition, and so forth, on a moving image file. Examples of the editing system include Apple Final Cut Pro, Avid Media Composer, and Adobe Premiere Pro.

The CG synthesizing system reproduces movement of a real camera by a virtual camera in a 3D CG space and synthesizes CG with a moving image file such that the movement of the CG is ganged with the movement of the real camera. To estimate the position and posture of the real camera, the CG synthesizing system performs tracking by extracting feature points from an image and inserts the position and posture of the camera from a hardware camera tracker (such as Stype RedSpy or Mo-Sys Star Tracker). In the CG synthesizing system, a plug-in made by a camera maker is incorporated for removing lens aberrations from a moving image file before CG synthesis. In the CG synthesizing system, by transferring the lens aberration correction data for each lens aberration to the plug-in, it is possible to apply lens aberration correction designed by the camera maker. Examples of the CG synthesizing system include Foundry Nuke, Adobe After Effects, Autodesk Flame, and Blackmagic Design Fusion.

The metadata file-outputting tool is an application made by a camera maker. When a moving image file recorded through shooting performed by a digital camera supported by the metadata file-outputting tool is read, the metadata file-outputting tool outputs metadata included in this moving image file as a metadata file. The metadata file is a separate file from the moving image file, and is e.g. a text file or an XML file. For example, in the work flow for virtual production, cut editing is sometimes performed on a moving image file before CG synthesis. At this time, the moving image file is sometimes converted to another file format, such as the Open EXR format. When the moving image file is converted to another file format, there are many cases where the metadata generated at a time of shooting and included in the moving image file is not transferred to the converted file. Therefore, in the PC 100, before the cut editing operation, processing for outputting the metadata included in the moving image file as a metadata file is performed by the metadata file-outputting tool.

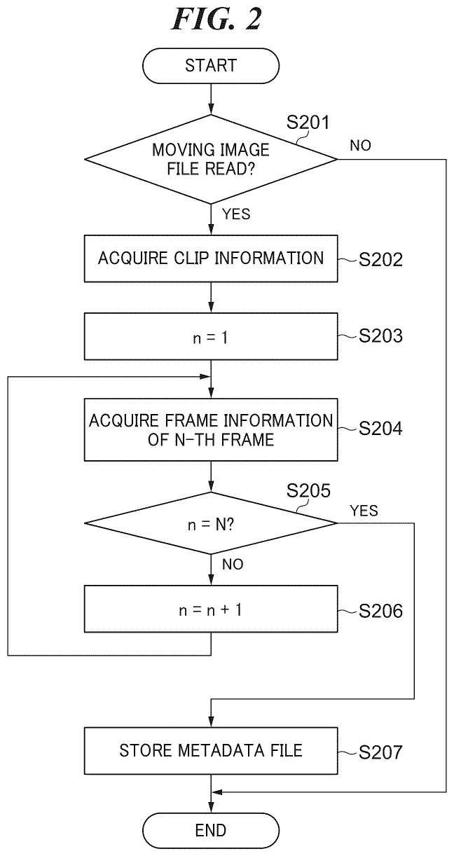

FIG. 2 is a flowchart of a metadata file output process performed by the PC 100 shown in FIG. 1. The metadata file output process is realized by the controller 101 that loads a program stored e.g. in the ROM 102 into the RAM 103 and executes the loaded program.

Referring to FIG. 2, first, the controller 101 determines whether or not a moving image file recorded through shooting performed by the digital camera supported by the metadata file-outputting tool has been read by the metadata file-outputting tool (S201).

If it is determined in the step S201 that a moving image file recorded through shooting performed by the digital camera supported by the metadata file-outputting tool has not been read by the metadata file-outputting tool, the present process is terminated. If it is determined in the step S201 that a moving image file recorded through shooting performed by the digital camera supported by the metadata file-outputting tool has been read by the metadata file-outputting tool, the present process proceeds to a step S202.

In the step S202, the controller 101 acquires information unique to the moving image file (hereinafter referred to as the “clip information”) from the read moving image file. The clip information includes a camera name, a lens name, a resolution, a frame rate, a color space-gamma setting at the time of shooting, the total number of frames of the moving image, settings of lens aberration correction, which have been made before shooting, and so forth. Note that the settings of lens aberration correction, which have been made before shooting, are respective ON/OFF settings of types of lens aberration correction, i.e. peripheral light amount correction, magnification chromatic aberration correction, distortion aberration correction, and focus breathing correction. The clip information acquired in the step S202 is stored in the RAM 103.

Then, in a step S203, the controller 101 sets a frame count n to 1. Then, in a step S204, the controller 101 acquires frame information set for the frame image corresponding to the frame count n. The frame information includes a focal length, an object distance, an aperture value, a color temperature, an ISO sensitivity, lens aberration correction data for each lens aberration, and so forth. The frame information acquired in the step S204 is also stored in the RAM 103.

Then, in a step S205, the controller 101 determines whether or not the frame count n is equal to the total number N of frames of the moving image file read in the step S201.

If it is determined in the step S205 that the frame count n is not equal to the total number N of frames of the moving image file read in the step S201, the present process proceeds to a step S206. In the step S206, the controller 101 adds 1 to the frame count n. Then, the present process returns to the step S204.

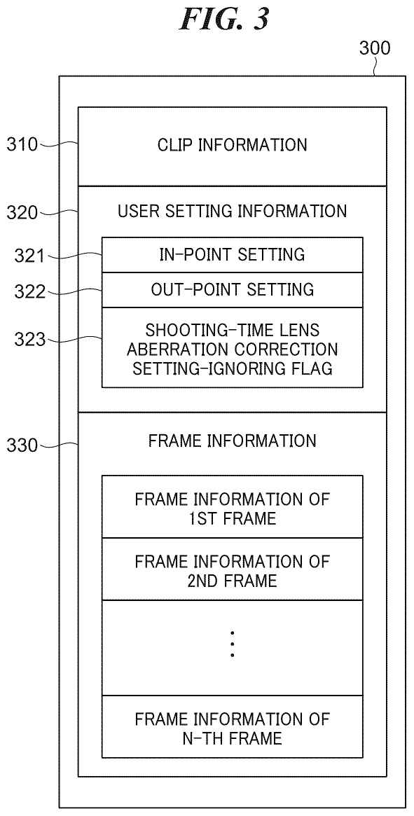

If it is determined in the step S205 that the frame count n is equal to the total number N of frames of the moving image file read in the step S201, the present process proceeds to a step S207. In the step S207, the controller 101 stores a metadata file 300, shown in FIG. 3, including the clip information and the frame information, stored in the RAM 103, and further including user setting information, described hereinafter, e.g. in the RAM 103 as a separate file from the moving image file, followed by terminating the present process.

FIG. 3 is a diagram showing an example of the configuration of the metadata file 300 output by the metadata file output process in FIG. 2. FIG. 3 shows the configuration of the metadata file 300 of the JASON format by way of example. Note that the file format of the metadata file 300 is not limited to the JASON format but can be any other suitable file format, such as the CSV format or the TXT format.

In the metadata file 300, clip information 310 and user setting information 320 are recorded at the top thereof, and next, frame information 330 is recorded for each frame of the total number of frames. Here, the user setting information 320 will be described. The user setting information 320 is formed by an in-point setting 321, an out-point setting 322, and a shooting-time lens aberration correction setting-ignoring flag 323. These are items for each of which a user can freely make a setting. For example, in a case where cut editing is performed by the editing system on a moving image file recorded by a digital camera, the user designates a frame number of the in-point and a frame number of the out-point, which have been designated in the cut editing, for the in-point setting 321 and the out-point setting 322, respectively. By referring to these settings by using the CG synthesizing system, it is possible to associate each frame image of the moving image file after conversion and each frame information of the metadata file.

The shooting-time lens aberration correction setting-ignoring flag 323 is used when determining lens aberration correction to be applied before CG synthesis. In the shooting-time lens aberration correction setting-ignoring flag 323, “false” is set as the default value, and the user can change the value to “true”. In a case where the shooting-time lens aberration correction setting-ignoring flag 323 has been set to “false”, the PC 100 determines lens aberration correction to be applied before CG synthesis, by using settings of lens aberration correction, which have been made before shooting. On the other hand, in a case where the shooting-time lens aberration correction setting-ignoring flag 323 has been set to “true”, the PC 100 applies all the applicable types of lens aberration correction to the determination of lens aberration correction to be applied before CG synthesis without using the settings of lens aberration correction, which have been made before shooting. Note that all the applicable types of lens aberration correction refers to peripheral light amount correction, magnification chromatic aberration correction, distortion aberration correction, and focus breathing correction.

Incidentally, although development processing is required to display a RAW moving image file, not only the application made by the camera maker, but also the editing system of the present embodiment supports RAW moving image development specified by a variety of camera makers. However, in the processing for developing the RAW moving image file, this editing system cannot always analyzing a metadata file output from the application made by the camera maker and hence cannot apply lens aberration correction according to settings of lens aberration correction, which are included in the metadata file. In this case, even when the user has made a setting for applying a certain type of lens aberration correction, before shooting, not only this lens aberration correction, but also the other types of lens aberration correction are not applied to development performed by the editing system. This causes a problem that the settings of lens aberration correction in the metadata file, and the applied state of lens aberration correction in the moving image file output by the editing system do not match, which makes it impossible to form the moving image file before CG synthesis into a state in which all lens aberrations have been removed.

On the other hand, in the present embodiment, whether or not to use settings of lens aberration correction, which have been made before capturing the moving image, is switched, and in a case where the settings are not used, all the applicable types of lens aberration correction are applied to the moving image file.

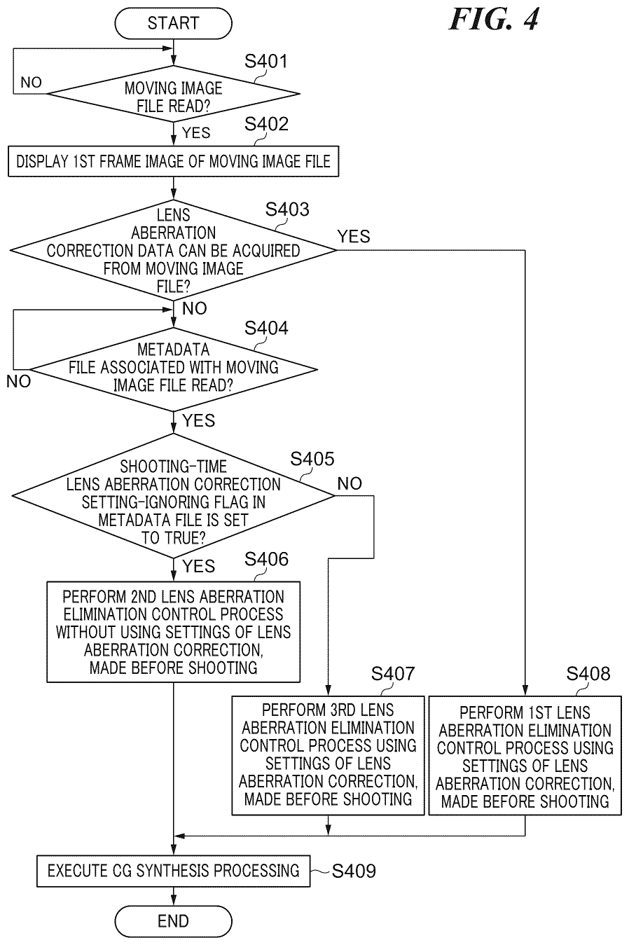

FIG. 4 is a flowchart of a CG synthesis control process performed by the PC 100 in the first embodiment. The CG synthesis control process in FIG. 4 is realized by the controller 101 that loads a program stored e.g. in the ROM 102 into the RAM 103 and executes the loaded program. The CG synthesis control process in FIG. 4 is started when the user inputs an instruction for performing CG synthesis to the PC 100, and the PC 100 starts the CG synthesizing system according to this instruction. When the CG synthesizing system is started, a screen (not shown) for performing an editing operation for synthesizing CG is displayed on the display section 106 of the PC 100. This screen includes a moving image display area for displaying a frame image which is designated by the user in the moving image file and with which CG is to be synthesized.

Referring to FIG. 4, first, in a step S401, the controller 101 determines whether or not a moving image file has been read by the CG synthesizing system. Here, as the moving image file read by the CG synthesizing system, a moving image file which has been developed by one of the application made by the camera maker and the editing system, or a camera-recorded moving image file is expected. If it is determined that a moving image file has not been read by the CG synthesizing system, the present process returns to the step S401.

If it is determined in the step S401 that a moving image file has been read by the CG synthesizing system, the present process proceeds to a step S402. In the step S402, the controller 101 displays the first frame image of the moving image file read in the step S401 in the moving image display area. Note that in the step S402, in a case where the moving image file read in the step S401 is a camera-recorded moving image file and is a RAW moving image file, development processing is applied to the first frame image of the moving image file. In this development processing, types of lens aberration correction for each of which an “ON” setting has been made before shooting are applied to the first frame image of the moving image file. Note that in a case where the moving image file read in the step S401 is a camera-recorded moving image file and is a non-RAW moving image file, the types of lens aberration correction for each of which the “ON” setting has been made before shooting have already been applied to each frame image of this moving image file by the digital camera. Further, in a case where the moving image file read in the step S401 is a moving image file which has been developed by the application made by the camera maker, the types of lens aberration correction for each of which the “ON” setting has been made before shooting has already been applied to each frame image of this moving image file when the moving image file has been developed. Thus, in the present embodiment, in a case where the moving image file read in the step S401 is a camera-recorded moving image file or a moving image file which has been developed by the application made by the camera maker, when the processing in the step S402 is completed, the types of lens aberration correction for each of which the “ON” setting have been made before shooting have already been applied to a frame image displayed in the moving image display area. On the other hand, in a case where the moving image file read in the step S401 is a moving image file which has been developed by the editing system, not only the types of lens aberration correction for each of which the “ON” setting has been made before shooting, but also the other types of lens aberration correction have not been applied to each frame image of this moving image file.

Then, in a step S403, the controller 101 determines whether or not lens aberration correction data necessary for lens aberration correction can be acquired from the moving image file read in the step S401. Here, as described above, the moving image file read in the step S401 is the moving image file developed by one of the application made by the camera maker and the editing system, or the camera-recorded moving image file. Out of these files, the camera-recorded moving image file includes the lens aberration correction data. Therefore, in the step S403, in a case where the moving image file read in the step S401 is the camera-recorded moving image file, it is determined that the lens aberration correction data necessary for lens aberration correction can be acquired from the moving image file read in the step S401. In this case, the present process proceeds to a step S408.

In the step S408, the controller 101 performs a first lens aberration elimination control process using the settings of lens aberration correction, which have been made before shooting. In the first lens aberration elimination control process, the controller 101 acquires the settings of lens aberration correction, which have been made before shooting, and the lens aberration correction data associated with the first frame image from the moving image file. Further, the controller 101 applies, out of the applicable types of lens aberration correction, only the types of lens aberration correction for each of which the “OFF” setting has been made before shooting to the first frame image of the moving image file, and displays a processing result in the moving image display area. For example, in a case where, the “OFF” setting has been made, before shooting, for only the peripheral light amount correction out of the types of lens aberration correction, i.e. peripheral light amount correction, magnification chromatic aberration correction, distortion aberration correction, and focus breathing correction, and the “ON” setting has been made for each of the other types, only the peripheral light amount correction is applied in the step S408. As described above, when the processing in the step S402 has been completed, the types of lens aberration correction for each of which the “ON” setting has been made before shooting have been applied to the first frame image of the camera-recorded moving image file. By further applying the types of lens aberration correction for each of which the “OFF” setting has been made before shooting to the frame image in the step S408, the frame image is formed into a state in which all lens aberrations have been removed. Then, the present process proceeds to a step S409, described hereinafter.

On the other hand, in the step S403, in a case where the moving image file read in the step S401 is a moving image file developed by one of the application made by the camera maker and the editing system, it is determined that lens aberration correction data necessary for lens aberration correction cannot be acquired from the moving image file read in the step S401. In this case, the present process proceeds to a step S404.

In the step S404, the controller 101 determines whether or not the metadata file 300 associated with the moving image file read in the step S401 has been read by the CG synthesizing system. If it is determined that the metadata file 300 associated with the moving image file read in the step S401 has not been read by the CG synthesizing system, the present process returns to the step S404.

If it is determined in the step S404 that the metadata file 300 associated with the moving image file read in the step S401 has been read by the CG synthesizing system, the present process proceeds to a step S405. In the step S405, the controller 101 determines whether or not the setting of the shooting-time lens aberration correction setting-ignoring flag 323, included in the metadata file 300 read in the step S404, is “true”. Note that in the present embodiment, as described above, the shooting-time lens aberration correction setting-ignoring flag 323 is set by the user. For example, when the user causes the CG synthesizing system to read a moving image file which has been developed by the editing system which cannot analyze the metadata file 300, the user sets the shooting-time lens aberration correction setting-ignoring flag 323 to “true”. On the other hand, when the user causes the CG synthesizing system to read a moving image file which has been developed by the application made by the camera maker, the user sets the shooting-time lens aberration correction setting-ignoring flag 323 to “false” which is the default value.

If it is determined in the step S405 that the setting of the shooting-time lens aberration correction setting-ignoring flag 323 is “true”, the present process proceeds to a step S406. In the step S406, the controller 101 performs a second lens aberration elimination control process without using the settings of lens aberration correction which have been made before shooting. In the second lens aberration elimination control process, the controller 101 acquires the lens aberration correction data associated with the first frame image from the frame information 330 of the metadata file 300. Further, the controller 101 applies all the applicable types of lens aberration correction to the first frame image of the moving image file and displays a processing result in the moving image display area. With this control, even if lens aberration correction has not been applied to the moving image file at all in the development processing performed by the editing system, all the applicable types of lens aberration correction are applied to the moving image file according to the setting of the shooting-time lens aberration correction setting-ignoring flag 323. That is, it is possible to form the moving image developed by the editing system into a state in which all lens aberrations have been removed. When the processing in the step S406 is completed, the present process proceeds to the step S409, described hereinafter.

If it is determined in the step S405 that the setting of the shooting-time lens aberration correction setting-ignoring flag 323 is not “true”, i.e. the setting of the shooting-time lens aberration correction setting-ignoring flag 323 is “false”, the present process proceeds to a step S407.

In the step S407, the controller 101 performs a third lens aberration elimination control process using the settings of lens aberration correction, which have been made before shooting. In the third lens aberration elimination control process, the controller 101 acquires the settings of lens aberration correction, which have been made before shooting, from the clip information 310 of the metadata file 300, and acquires the lens aberration correction data associated with the first frame image from the frame information 330 of the metadata file 300. Further, the controller 101 applies only the types of lens aberration correction for each of which the “OFF” setting has been made before shooting to the first frame image of the moving image file and displays a processing result in the moving image display area. As described above, to each frame image of the moving image file developed by the application made by the camera maker, the types of lens aberration correction for each of which the “ON” setting has been made before shooting have been applied when the moving image has been developed. By further applying the types of lens aberration correction for each of which the setting of “OFF” has been made before shooting to the frame image in the step S408, the frame is formed into a state in which all lens aberrations have been removed. After that, the present process proceeds to the step S409.

In the step S409, the controller 101 performs CG synthesis processing according to an instruction received from the user. The real shot video used in this step is in a state in which all the applicable types of lens aberration correction have been applied whereby all lens aberrations have been removed, and hence it is possible to realize CG synthesis without giving a sense of incongruity. When the CG synthesis processing is completed, the present process is terminated.

Note that although in the above-described embodiment, the process performed on the first frame image of the moving image file has been described by way of example, the same process is also applied to the frame images after the first frame image. For example, in a case where the user selects the second frame image, the same processing, out of the processing operations in the step S406 to S408, as executed on the first frame image, is executed on the second and following frame images. Note that in a case where the moving image file read in the step S401 is a camera-recorded moving image file and is a RAW moving image file, development processing is applied to the selected second frame image. In this development processing, the types of lens aberration correction for each of which the “ON” setting has been made before shooting are applied to the selected second frame image. Thus, it is possible to apply all the applicable types of lens aberration correction to the frame image selected by the user and form the moving image into a state in which all lens aberrations have been removed before CG synthesis.

According to the above-described first embodiment, in the CG synthesis control process performed by the PC 100, whether or not to use the settings of lens aberration correction, which have been made before capturing a moving image, is switched, and in a case where these settings are not used, all the applicable types of lens aberration correction are applied to the moving image file. That is, there is provided means for applying all the applicable types of lens aberration correction to a moving image file without using the settings of lens aberration correction, which have been made before capturing a moving image. This makes it possible to cope with a case where the settings of types of lens aberration correction, which have been made before capturing a moving image, and an applied state of lens aberration correction in the moving image file output by the editing system do not match. As a result, it is possible to apply all the applicable types of lens aberration correction to the moving image file before CG synthesis.

Further, in the above-described first embodiment, all the applicable types of lens aberration correction are peripheral light amount correction, magnification chromatic aberration correction, distortion aberration correction, and focus breathing correction. With this, it is possible to apply these types of lens aberration correction to a moving image file before CG synthesis.

Further, in the above-described first embodiment, whether or not to use the settings of lens aberration correction, which have been made before capturing a moving image, is switched based on a setting of the shooting-time lens aberration correction setting-ignoring flag 323, which has been made by the user. With this, it is possible to reflect user's intention in switching whether or not to use the settings of lens aberration correction, which have been made before capturing a moving image.

Next, the information processing apparatus and a method of controlling the same in a second embodiment of the present disclosure will be described.

The second embodiment basically has the same configuration and advantageous effects as the above-described first embodiment but is different from the first embodiment in that whether or not to use settings of lens aberration correction, which are made before capturing a moving image, is determined based on a type of applied development processing. Therefore, redundant description of configuration and effects is omitted, and the following description will be given of different configuration and effects.

In the above-described first embodiment, for example, a user can forget to set the shooting-time lens aberration correction setting-ignoring flag 323 to “true” even though the user causes the CG synthesizing system to read a moving image file developed by the editing system which cannot analyze the metadata file 300. In this case, it is impossible to apply all the applicable types of lens aberration correction to the moving image file before CG synthesis.

In contrast, in the second embodiment, whether or not to use the settings of lens aberration correction, which have been made before capturing a moving image, is determined based on a type of applied development processing.

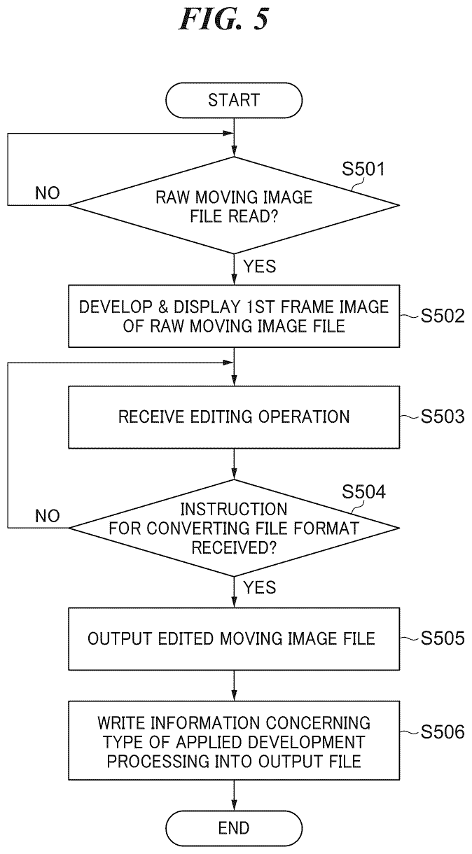

FIG. 5 is a flowchart of a file format conversion process performed by the PC 100 in the second embodiment. The file format conversion process in FIG. 5 is realized by the controller 101 that loads a program stored e.g. in the ROM 102 into the RAM 103 and executes the loaded program. The file format conversion process in FIG. 5 is started when the user inputs an instruction for editing a RAW moving image file to the PC 100 as preparation before CG synthesis, and the PC 100 starts the editing system according to this instruction. When the editing system is started, a screen (not shown) for performing an operation of editing the RAW moving image file is displayed on the display section 106 of the PC 100. This screen includes a moving image display area for displaying a frame image designated by the user in the RAW moving image file, which is a frame image to be edited.

Referring to FIG. 5, first, in a step S501, the controller 101 determines whether or not a RAW moving image file has been read by the editing system. If it is determined that a RAW moving image file has not been read by the editing system, the present process returns to the step S501. If it is determined that a RAW moving image file has been read by the editing system, the present process proceeds to a step S502.

In the step S502, the controller 101 controls the editing system to perform development processing on the first frame image of the RAW moving image file read in the step S501 and displays the developed frame image in the moving image display area.

Then, in a step S503, the controller 101 receives an editing operation from the user. The editing operation performed by the user includes setting of an in-point and an out-point, white balance adjustment, setting of a color space-gamma setting, and so forth, on the RAW moving image file. Here, some editing systems incorporate a library provided by the camera maker so as to make it possible to perform development processing by processing designed by the camera maker. In such an editing system, it is possible to select which of development processing designed by the editing system maker and development processing designed by the camera maker is to be executed. In a case where the development processing using the library provided by the camera maker is selected, this editing system can analyze metadata included in the RAW moving image file. Therefore, this editing system can read out settings of lens aberration correction, which have been made before shooting, and the lens aberration correction data, from the metadata, and apply the types of lens aberration correction for each of which the “ON” setting has been made before shooting, when developing the RAW moving image file. On the other hand, in a case where the development processing designed by the editing system maker, which does not use the library provided by the camera maker, is selected, this editing system cannot analyze the metadata included in the RAW moving image file. Therefore, when developing the RAW moving image file, this editing system cannot apply not only the types of lens aberration correction for each of which the “ON” setting has been made before shooting, but also the other types of lens aberration correction.

Then, in a step S504, the controller 101 determines whether or not an instruction for converting the file format to a predetermined format (such as MP4) has been received for the RAW moving image file edited according to the editing operation received in the step S503. If it is determined that an instruction for converting the file format to a predetermined format has not been received, the present process returns to the step S503. If it is determined that an instruction for converting the file format to a predetermined format has been received, the present process proceeds to a step S505.

In the step S505, the controller 101 performs the development processing on the frame images of a section between the in-point and the out-point of the RAW moving image file according to predetermined development settings and outputs a moving image file which has been edited, including the developed frame images and voice data.

Then, in a step S506, the controller 101 writes information concerning the type of the applied development processing in the metadata area of the edited moving image file, which has been output in the step S505. Note that the information concerning the type of the applied development processing is information indicating which of the development processing designed by the editing system maker and the development processing designed by the camera maker has been applied. When the step S506 is completed, the present process is terminated.

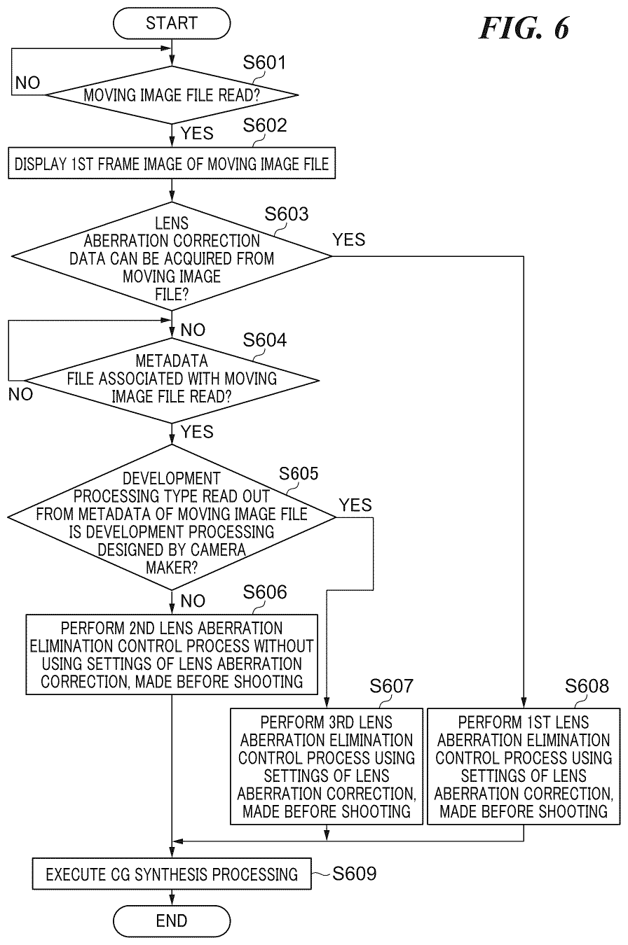

FIG. 6 is a flowchart of a CG synthesis control process performed by the PC 100 in the second embodiment. Note that the CG synthesis control process in FIG. 6 is similar to the above-described CG synthesis control process in FIG. 4, and the following description will be given mainly of different points from the CG synthesis control process in FIG. 4. Similar to the CG synthesis control process described with reference to FIG. 4, the CG synthesis control process in FIG. 6 is also realized by the controller 101 that loads a program stored e.g. in the ROM 102 into the RAM 103 and executes the loaded program. Further, similar to the CG synthesis control process described with reference to FIG. 4, the CG synthesis control process in FIG. 6 is also started when the user inputs an instruction for performing CG synthesis to the PC 100, and the PC 100 starts the CG synthesizing system according to this instruction.

Referring to FIG. 6, first, steps S601 and S602, which are same processing operations as the step S401 and S402, are executed. Then, in a step S603, the controller 101 determines whether or not the lens aberration correction data necessary for lens aberration correction can be acquired from the moving image file read in the step S601. Note that the determination method used in the step S603 is the same as that in the step S403.

If it is determined in the step S603 that the lens aberration correction data necessary for lens aberration correction can be acquired from the moving image file read in the step S601, a step S608 which is the same processing as the step S408 is executed. Then, a step S609 which is the same processing as the above-described step S409 is executed, followed by terminating the present process.

If it is determined in the step S603 that the lens aberration correction data necessary for lens aberration correction cannot be acquired from the moving image file read in the step S601, the present process proceeds to a step S604. In the step S604, the controller 101 determines whether or not the metadata file 300 associated with the moving image file read in the step S601 has been read by the CG synthesizing system. If it is determined that the metadata file 300 associated with the moving image file read in the step S601 has not been read by the CG synthesizing system, the present process returns to the step S604.

If it is determined in the step S604 that the metadata file 300 associated with the moving image file read in the step S601 has been read by the CG synthesizing system, the present process proceeds to a step S605.

In the step S605, the controller 101 determines whether or not information read out from the metadata of the moving image data read in the step S601, which is concerned with the type of the applied development processing, indicates the development processing designed by the camera maker.

If it is determined in the step S605 that the information read out from the metadata of the moving image data read in the step S601 does not indicate the development processing designed by the camera maker, i.e. the read information indicates the development processing designed by the editing system maker, the present process proceeds to a step S606. In the step S606, similar to the above-described step S406, the controller 101 performs the second lens aberration elimination control process without using the settings of lens aberration correction, which have been made before shooting. In the development processing designed by the editing system maker, as described above, not only the types of lens aberration correction for each of which the “ON” setting has been made before shooting, but also the other types of lens aberration correction have not been applied to the moving image file. To this moving image file, all the types of lens aberration correction are applied by performing the second lens aberration elimination control process. That is, it is possible to form the moving image file on which the development processing designed by the editing system maker has been performed into a state in which all lens aberrations have been removed. After that, the present process proceeds to the step S609.

If it is determined in the step S605 that the information read out from the metadata of the moving image data read in the step S601 indicates the development processing designed by the camera maker, the present process proceeds to a step S607. In the step S607, similar to the above-described step S407, the controller 101 performs the third lens aberration elimination control process using settings of lens aberration correction, which have been made before shooting. In the development processing designed by the camera maker, as described above, the types of lens aberration correction for each of which the “ON” setting has been made before shooting are applied to the moving image file. By performing the third lens aberration elimination control process on this moving image file, the types of lens aberration correction for each of which the “OFF” setting has been made before shooting are also applied. That is, it is possible to form the moving image file on which the development processing designed by the camera maker has been performed into a state in which all lens aberrations have been removed. After that, the present process proceeds to the step S609.

Note that although in the above-described embodiment, the process performed on the first frame image of the moving image file has been described by way of example, the same process is also applied to the frame images after the first frame image. For example, in a case where the user selects the second frame image, the same processing, out of the processing operations in the step S606 to S608, as executed on the first frame image, is executed on the second frame image. Note that in a case where the moving image file read in the step S601 is a camera-recorded moving image file and is a RAW moving image file, the development processing is applied to the selected second frame image. In this development processing, the types of lens aberration correction for each of which the “ON” setting has been made before shooting are applied to the selected second frame image. Thus, to the frame image selected by the user, by eventually applying all the applicable types of lens aberration correction, it is possible to form the moving image into a state in which all lens aberrations have been removed before CG synthesis.

In the above-described second embodiment, in a case where the information read out from the metadata of the moving image file indicates the development processing designed by the camera maker, it is determined to use the settings of lens aberration correction, which have been made before capturing a moving image. In a case where the information read out from the metadata of the moving image file does not indicate the development processing designed by the camera maker, it is determined not to use the settings of lens aberration correction, which have been made before capturing a moving image. This makes it possible to properly switch whether or not to use settings of lens aberration correction, which have been made before capturing a moving image, according to the type of the applied development processing.

Note that although in the second embodiment, the configuration that writes the information concerning the type of the applied development processing into the metadata of the moving image file edited by the editing system has been described, the present disclosure is not limited to this. For example, in the metadata of the moving image file edited by the editing system, the name of this editing system can be written. With this, it is possible to properly switch whether or not to use settings of lens aberration correction, which have been made before capturing a moving image, according to the type of the application which has performed the development processing.

Further, in the second embodiment, when the editing system applies the development processing designed by the camera maker, the editing system can embed a digital watermark for identifying the development processing designed by the camera maker in a development result. In this configuration, whether or not the development processing applied to the moving image file is the development processing designed by the camera maker is determined based on presence/absence of this digital watermark. For example, in a case where a plug-in incorporated in the CG synthesizing system has extracted this digital watermark, it is determined that the development processing applied to the moving image file is the development processing designed by the camera maker. In this case, in the above-described CG synthesis control process in FIG. 6, the processing in the step S607 is executed on a frame image selected by the user. On the other hand, in a case where the plug-in incorporated in the CG synthesizing system has not extracted this digital watermark, it is determined that the development processing applied to the moving image file is not the development processing designed by the camera maker but is the development processing designed by the editing system maker. In this case, in the above-described CG synthesis control process in FIG. 6, the processing in the step S606 is executed on a frame image selected by the user. In this configuration, it is also possible to obtain the same advantageous effects as provided by the above-described embodiment.

Further, in the present embodiment, control to display a UI on the plug-in incorporated in the CG synthesizing system can be performed. This UI prompts the user to select whether to determine types of lens aberration correction to be applied using settings of lens aberration correction, which have been made before shooting, or apply all the applicable types of lens aberration correction without using the settings of lens aberration correction, which have been made before shooting. Further, this UI can further prompt the user to select types of lens aberration correction to be applied.

Incidentally, in the CG synthesis, conversion processing is sometimes applied so as to adjust the color space-gamma setting for the real shot video to the color space-gamma setting for the CG. On the other hand, in the editing system, there is a case where when a moving image file is converted to another format, the color space-gamma setting is changed by a user, and the changed color space-gamma setting does not coincide with the color space-gamma setting written in the metadata file. At this time, not the color space-gamma setting in the metadata file, but the color space-gamma setting in the converted moving image itself can be acquired, and when lens aberration correction is applied, processing for converting the color space-gamma can be performed at the same time. In a case where the color space-gamma setting, which has been set by the editing system, is not a general color space-gamma setting but a format specific to the editing system, the plug-in made by the camera maker cannot perform conversion, and hence a warning can be displayed.

Further, the present disclosure can be applied not only to the case where lens aberrations are removed before CG synthesis, but also to a case where lens aberrations are added to a result of CG synthesis. When adding lens aberrations to a result of CG synthesis, the determination operations in the step S405 and S605 are performed. For example, if the answer to the question of the step S405 is negative (NO), lens aberrations to be added are determined using settings of lens aberration correction, which have been made before shooting, whereas if the answer to the question of the step S405 is affirmative (YES), all the lens aberrations which can be added are added without using the settings of lens aberration correction, which have been made before shooting. Further, if the answer to the question of the step S605 is affirmative (YES), lens aberrations to be added are determined using the settings of lens aberration correction, which have been made before shooting, whereas if the answer to the question of the step S605 is negative (NO), all lens aberrations which can be added are added without using the settings of lens aberration correction, which have been made before shooting.

As a specific example, a RAW moving image file recorded by the digital camera through shooting with the setting of peripheral light amount correction, set to “OFF”, and the setting of distortion aberration correction, set to “ON”, will be described. Note that in a case where lens aberrations are added to a result of CG synthesis, the necessity of adding lens aberrations as a video effect is low with respect to the magnification chromatic aberration and the focus breathing, and hence ON/OFF settings of lens aberration addition processing with respect to the peripheral light amount and the distortion aberration will be described in this example. In the metadata of the above-described RAW moving image file, information on an OFF setting of peripheral light amount correction and an ON setting of distortion aberration correction is written. In a case where this RAW moving image file is input to the metadata file-outputting tool, the information on the OFF setting of peripheral light amount correction and the ON setting of distortion aberration correction is written into the clip information 310 of the metadata file 300, as the settings of lens aberration correction, which have been made before shooting. When lens aberrations are added using this metadata file 300, in a case where the shooting-time lens aberration correction setting-ignoring flag 323 in the metadata file 300 is set to “false”, the peripheral light amount aberration is added to the result of CG synthesis. On the other hand, in a case where the shooting-time lens aberration correction setting-ignoring flag 323 is set to “true”, the peripheral light amount aberration and the distortion aberration are added to the result of CG synthesis. By thus performing processing, it is possible to control whether to restore the result of CG synthesis into a state of the settings of lens aberration correction, which have been made before shooting, or to form the result of CG synthesis into a state in which all lens aberrations are added.

Note that although in the present embodiment, the configuration in which the CG synthesizing system can analyze the metadata included in the RAW moving image file has been described, in a case where the CG synthesizing system cannot originally analyze the metadata, it is impossible to identify settings of lens aberration correction, which have been made before shooting. As a result, it is impossible to apply all the applicable types of lens aberration correction to the RAW moving image file before CG synthesis. On the other hand, the PC 100 can be configured to determine whether or not the read moving image file is a moving image file recorded by an image capturing apparatus of a specific model supported by the CG synthesizing system. If the read moving image file is a moving image file recorded by the image capturing apparatus of the specific model supported by the CG synthesizing system, it is determined to use the settings of lens aberration correction, which have been made before shooting, and the above-described third lens aberration elimination control process is performed. On the other hand, if the read moving image file is not a moving image file recorded by the image capturing apparatus of the specific model supported by the CG synthesizing system, it is determined not to use the settings of lens aberration correction, which have been made before shooting, and the above-described second lens aberration elimination control process is performed. With this control, even in a case where the metadata of the read moving image file cannot be analyzed by the CG synthesizing system, it is possible to apply all the applicable types of lens aberration correction to the RAW moving image file before CG synthesis.

Further, depending on the lens attached to the digital camera, lens distortion is large, and hence there is a lens to which distortion aberration correction is necessarily applied. In this case, an ON/OFF setting of distortion aberration correction cannot be switched by the menu setting of the digital camera, and the distortion aberration correction setting before shooting is always set to “ON”. In a case where lens aberrations are added to a result of CG synthesis for a moving image recorded by attaching the lens to which distortion aberration correction is necessarily applied, there is a concern that distortion as a video effect is added more than necessary. Therefore, even when the shooting-time lens aberration correction setting-ignoring flag 323 in the metadata file 300 is set to “true”, application of the distortion aberration can be inhibited.

According to the present disclosure, it is possible to apply all applicable lens aberration correction to a moving image file before CG synthesis.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084083 filed May 23, 2024, which is hereby incorporated by reference herein in its entirety.

What is claimed is:

1. An information processing apparatus that performs CG synthesis on an acquired moving image file, comprising:
at least one processor; and
a memory coupled to the at least one processor storing instructions that, when executed by the processor, cause the processor to function as:
an application unit configured to apply lens aberration correction for removing lens aberrations to the moving image file before performing the CG synthesis; and
a switching unit configured to switch whether or not to use settings of lens aberration correction, which have been made before capturing the moving image,
wherein in a case where the settings are used, the application unit applies non-applied types of lens aberration correction, which are identified based on the settings, to the moving image file, whereas in a case where the settings are not used, the application unit applies all applicable types of lens aberration correction to the moving image file.

2. The information processing apparatus according to claim 1, wherein in a case where the settings are used, the application unit adds, out of a plurality of lens aberrations which can be added, a lens aberration determined based on the settings, to the moving image file having been subjected to the CG synthesis, whereas in a case where the settings are not used, the application unit adds all lens aberrations which can be added, to the moving image file having been subjected to the CG synthesis.

3. The information processing apparatus according to claim 1, wherein all the applicable types of lens aberration correction are peripheral light amount correction, magnification chromatic aberration correction, distortion aberration correction, and focus breathing correction.

4. The information processing apparatus according to claim 1, wherein the processor is caused to further function as a reading unit configured to read a metadata file generated based on metadata included in the moving image file,
wherein the switching unit switches whether or not to use the settings of lens aberration correction, which have been made before capturing the moving image, based on flag information included in the metadata file, and
wherein the flag information is flag information indicating whether or not to use the settings of lens aberration correction, which have been made before capturing the moving image, and is set by a user operating the information processing apparatus.

5. The information processing apparatus according to claim 1, wherein the processor is caused to further function as an acquisition unit configured to acquire, from the moving image file, information indicating a type of development processing applied to the moving image file, and
wherein in a case where the acquired information indicates development processing using a library provided by a maker of an image capturing apparatus which has recorded the moving image file, the switching unit determines to use the settings of lens aberration correction, which have been made before capturing the moving image, whereas in a case where the acquired information does not indicate the development processing using the library, the switching unit determines not to use the settings of lens aberration correction, which have been made before capturing the moving image.

6. The information processing apparatus according to claim 1, wherein the processor is caused to further function as an acquisition unit configured to acquire, from the moving image file, information indicating a system that has output the moving image file, and
wherein in a case where the acquired information indicates a system provided by a maker of an image capturing apparatus which has recorded the moving image file, the switching unit determines to use the settings of lens aberration correction, which have been made before capturing the moving image, whereas in a case where the acquired information does not indicate a system provided by the maker of the image capturing apparatus which has recorded the moving image file, the switching unit determines not to use the settings of lens aberration correction, which have been made before capturing the moving image.

7. The information processing apparatus according to claim 4, wherein the processor is caused to further function as a determination unit configured to determine whether or not the moving image file includes a digital watermark for identifying development processing using a library provided by a maker of an image capturing apparatus which has recorded the moving image file, and
wherein in a case where the moving image file includes the digital watermark, the switching unit determines to use the settings of lens aberration correction, which have been made before capturing the moving image, whereas in a case where the moving image file does not include the digital watermark, the switching unit determines not to use the settings of lens aberration correction, which have been made before capturing the moving image.

8. The information processing apparatus according to claim 1, wherein the processor is caused to further function as a determination unit configured to determine whether or not the moving image file is a moving image file recorded by a specific image capturing apparatus, and
wherein in a case where it is determined that the moving image file is a moving image file recorded by the specific image capturing apparatus, the switching unit determines to use the settings of lens aberration correction, which have been made before capturing the moving image, whereas in a case where it is determined that the moving image file is not a moving image file recorded by the specific image capturing apparatus, the switching unit determines not to use the settings of lens aberration correction, which have been made before capturing the moving image.

9. The information processing apparatus according to claim 1, wherein the moving image file is a moving image file generated by converting a file format of a RAW moving image file recorded by an image capturing apparatus to another file format.

10. A method of controlling an information processing apparatus that performs CG synthesis on an acquired moving image file, comprising:
applying lens aberration correction for removing lens aberrations to the moving image file before performing the CG synthesis; and
switching whether or not to use settings of lens aberration correction, which have been made before capturing the moving image,
wherein in a case where the settings are used, the applying includes applying non-applied types of lens aberration correction, which are identified based on the settings, to the moving image file, whereas in a case where the settings are not used, the applying includes applying all applicable types of lens aberration correction to the moving image file.

11. A non-transitory computer-readable storage medium storing a program for causing a computer to execute a method of controlling an information processing apparatus that performs CG synthesis on an acquired moving image file,
wherein the method comprises:
applying lens aberration correction for removing lens aberrations to the moving image file before performing the CG synthesis; and
switching whether or not to use settings of lens aberration correction, which have been made before capturing the moving image,
wherein in a case where the settings are used, the applying includes applying non-applied types of lens aberration correction, which are identified based on the settings, to the moving image file, whereas in a case where the settings are not used, the applying includes applying all applicable types of lens aberration correction to the moving image file.
